(19) United States
(12) Patent Application Publication
(10) Pub. No.: US 2025/0262464 A1
(43) Pub. Date: Aug. 21, 2025

(54) MULTI-PURPOSE FIREFIGHTING TOOL

(71) Applicants: John Olden Allen Lawless, Temple, TX (US); Wayne Thomas Allen Lawless, Rogers, TX (US)

(72) Inventors: John Olden Allen Lawless, Temple, TX (US); Wayne Thomas Allen Lawless, Rogers, TX (US)

(21) Appl. No.: 19/058,187

(22) Filed: Feb. 20, 2025

Related U.S. Application Data
(60) Provisional application No. 63/555,885, filed on Feb. 20, 2024.

(51) Int. Cl. A62B 3/00

(52) U.S. Cl. CPC A62B 3/005

(57) ABSTRACT

A multi-purpose firefighting tool includes an elongate handle extending between butt and neck ends. An axe head portion mounted to the neck end has opposed front and rear ends. A pick-head extends forwardly from the front end of the axe head and has a pointed configuration for prying open a structure. The axe head includes a bridge that connects the front end of the head portion to the pick-head, the bridge including a ring to which a safety rope may be secured and deployed. A beard extends from the rear end and defines an impact surface that is parallel to the handle. The beard includes an inner surface opposite the impact surface having a rounded configuration that merges with the axe head. The pick-head is detachably coupled to a forked end of a Halligan bar such that the Halligan bar is selectively simultaneously transported with the firefighting tool.

### REFERENCE TO RELATED APPLICATIONS

This is a non-provisional patent application claiming the priority of provisional application 63/555,885 filed Feb. 20, 2024, Firefighting Axe, which is incorporated herein by reference.

### BACKGROUND OF THE INVENTION

This invention relates generally to firefighting tools and, more particularly, to a multipurpose firefighting axe and striking tool that improves the speed and efficiency of ground operations associated with fighting structure fires.

Firefighting is a demanding and high-risk profession that requires specialized tools to effectively combat fires, perform rescues, and ensure firefighter safety. Among the most essential tools used in firefighting operations are those designed for forcible entry and ventilation, such as the firefighting axe and the Halligan tool. These tools play a critical role in tearing open vent holes in structures to release heat and smoke, as well as in gaining rapid access to buildings for rescue operations. Without these essential tools, both firefighters and victims would face increased dangers due to limited visibility, extreme heat, and structural barriers. By equipping firefighters with the right tools and proper training, fire departments enhance their ability to save lives and protect property in the face of devastating fires.

One of the primary reasons for ventilating a burning structure is to improve visibility and air quality for both trapped individuals and responding firefighters. Smoke inhalation is a leading cause of fire-related fatalities, and properly ventilating a structure can significantly enhance survivability. The firefighting axe, typically featuring a sharp blade on one side and a pointed pick on the other, is an indispensable tool for creating ventilation openings in roofs and walls. Firefighters use the axe to break through barriers that would otherwise trap smoke and heat inside, reducing the chances of flashover-a deadly event where accumulated heat causes an entire room to suddenly ignite.

In addition to ventilation, quick access to a structure is often necessary to rescue individuals or pets trapped inside. The Halligan tool, a versatile forcible entry tool, is designed to pry open doors, break windows, and breach barriers in emergency situations. With its combination of a claw, a wedge, and a pointed end, the Halligan tool provides firefighters with the leverage and strength needed to bypass locked or obstructed entry points. When time is critical, the ability to rapidly force open doors and windows can mean the difference between life and death for those awaiting rescue.

The combination of a firefighting axe and a Halligan tool is so effective that many firefighters consider them both to be part of a standard forcible entry set. When used in tandem, these tools maximize efficiency in breaking through obstacles, whether to ventilate a building or to provide emergency access. Firefighters train extensively in their use, ensuring they can deploy them swiftly and effectively under extreme conditions. Any design advantages, therefore, that enables firefighters to use these tools efficiently would be welcomed.

Although traditional firefighting tools such as an axe and a Halligan bar are presumably effective for their intended purposes, it would be desirable to have a multi-purpose firefighting tool that offers a significant improvement over the traditional axe, enables the improved axe to be carried single-handedly in tandem with a Halligan tool and to enable fast deployment of a safety rope by which a firefighter may repel to a position of safety.

### SUMMARY OF THE INVENTION

A firefighting apparatus according to the present invention includes a handle having an elongate and linear configuration extending between a butt end and a neck end. The apparatus includes an axe head portion mounted to the neck end of the handle, the axe head portion having opposing front and rear ends. In another aspect, the firefighting apparatus includes a pick-head operably mounted to the front end of the axe head portion, the pick-head having a pointed configuration suitable for prying open a structure. In an embodiment, the pick-head may have a configuration making it suitable for use as a forcible entry wedge for progress capture. In other words, the pick may be capable of a ratcheting movement so that a structure can be pried apart or opened incrementally.

In another aspect, a beard is mounted to the rear end of the axe head portion, the beard defining (1) a rear surface that is elongate, planar, and parallel to the handle and (2) an inner surface opposite the rear surface that defines a forwardly ascending configuration that merges with the axe head portion. Importantly, one important function of the beard is to prevent overstrikes and to prevent the tool from becoming stuck in material that has been struck and potentially penetrated. Further, a bridge member extends between and connects the front end of the axe head portion to the pick-head, the bridge member defining a ring configured to receive and secure a safety rope for deployment therefrom. The bridge and pick-head, together, define a slot for selectively receiving a forked end of a Halligan tool so that the firefighting apparatus and Halligan tool may be transported together and single-handedly. Further, the end of the Halligan tool opposite the forked end may also be configured to be coupled to or supported by the butt end of the handle. In other words, there may be 2 or even 3 points of contact locking the Halligan to the present firefighting apparatus

Therefore, a general object of this invention is to provide a firefighting apparatus that includes an ax handle and axe head portion situated atop the handle, the axe head portion including a pick-head having a pointed or tapered configuration suitable for prying open house or building structures and fixtures.

Another object of this invention is to provide a firefighting apparatus, as aforesaid, in which the axe head portion has a rear end and a beard coupled to said rear end, the beard having a downwardly elongate configuration and a planar rear edge referred to as a strike plate configured to disrupt or destroy building structures that are impacted thereby.

Still another object of this invention is to provide a firefighting apparatus, as aforesaid, having a bridge or interface member that extends between and connects a body section of the axe head portion to the pick-head, the bridge member and pick-head, together, define a slot configured for receiving a Halligan tool.

Other objects and advantages of the present invention will become apparent from the following description taken in connection with the accompanying drawings, wherein is set forth by way of illustration and example, embodiments of this invention.

### BRIEF DESCRIPTION OF THE DRAWINGS

FIG. 1a is a perspective view of a multipurpose firefighting apparatus according to a preferred embodiment of the present invention;

FIG. 1b is an exploded view of the firefighting apparatus as in FIG. 1a;

FIG. 2a is a side view of the firefighting apparatus as in FIG. 1a;

FIG. 2b is an isolated view on an enlarged scale taken from FIG. 2a;

FIG. 3a is another perspective view of the firefighting apparatus, illustrated holding a Halligan tool from another orientation;

FIG. 3b is an isolated view on an enlarged scale taken from FIG. 3a;

FIG. 4a is a side view of the firefighting apparatus as in FIG. 3a;

FIG. 4b is an isolated view on an enlarged scale taken from FIG. 4a;

FIG. 5 is another perspective view of the firefighting apparatus as in FIG. 1a, illustrated from a bottom perspective;

FIG. 6a is a side view of the firefighting apparatus according to the present invention; and

FIG. 6b is an isolated view on an enlarged scale taken from FIG. 6a.

### DESCRIPTION OF THE PREFERRED EMBODIMENT

A multipurpose firefighting tool according to a preferred embodiment of the present invention will now be described with reference to the accompanying drawings. The firefighting tool 10 includes a handle 15, an axe head portion 20, a pick-head 24, a bridge member 30, and a beard 40.

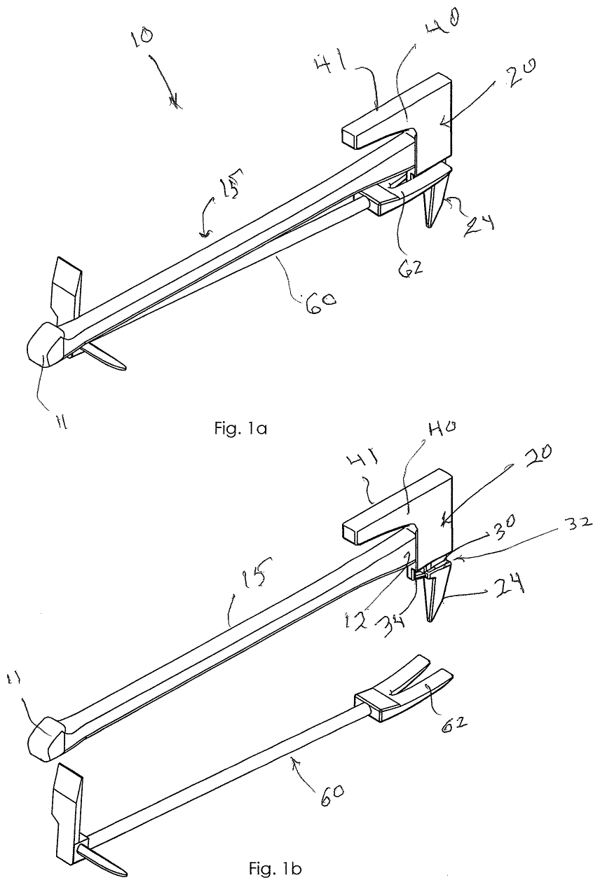

As shown in FIG. 1, the multipurpose firefighting tool, also referred to as a firefighting apparatus, is a tool intended to be carried and operated by a firefighter and, therefore, includes a handle 15 by which the tool may be grasped and carried by a fireman. Preferably, a firefighter may carry the apparatus 10 using a single hand although it is most likely swung and operated using both hands. More particularly, the handle 10 has an elongate and linear configuration that extends between opposed ends. The lower end may be referred to as the butt end 11 and the upper end is referred to as the neck end 12. In an embodiment, a Halligan tool 60 may be coupled to and carried in parallel with the handle 15 as will be described later in more detail. Preferably, the handle 15 is lighter in weight than other portions of the tool and may be constructed of wood although use of fiberglass, steel, aluminum, or composite materials may also work.

In a critical aspect, the firefighting apparatus 10 includes an axe head portion 20 situated atop and mounted to the neck end 12 of the handle 15. The axe head portion 20 may have a predetermined width or thickness and has a solid construction such as being constructed of steel. The head portion must be made of a durable material as it will be struck or slammed repeatedly against building materials that may be afire or that need to be cleared away quickly to gain access to a building. More particularly, the axe head portion 20 may include a front and 21a and a rear end 21b opposite the front end 21a. In an embodiment, the axe head portion 20 may be described as having opposed front and rear edges to which other components may be integrated and coupled.

In another critical aspect, the firefighting apparatus 10 includes a pick-head 24 may be operably coupled to the front end 21a or front edge of the axe head 20. Preferably, the pick-head 24 has a forwardly pointed configuration. Accordingly, the pick-head 24 is situated perpendicular to an imaginary longitudinal axis defined by the handle 15. Further, the pick-head 24 has a pointed or tapered configuration that is well-suited for prying structures apart when those structures are impacted by the aggressive swinging action of the firefighter. For instance, the firefighter may use the pick-head 24 two pry open the door, window frame, or a wall. In an embodiment, the pick-head 24 may have a movable assembly that functions similar to a ratchet tool so a enable the concept of progress capture. In other words, multiple reciprocal movements of the pick-head 24 may act as wedge that increasingly increases an opening or whereby to gain access or to incrementally enlarge an access point.

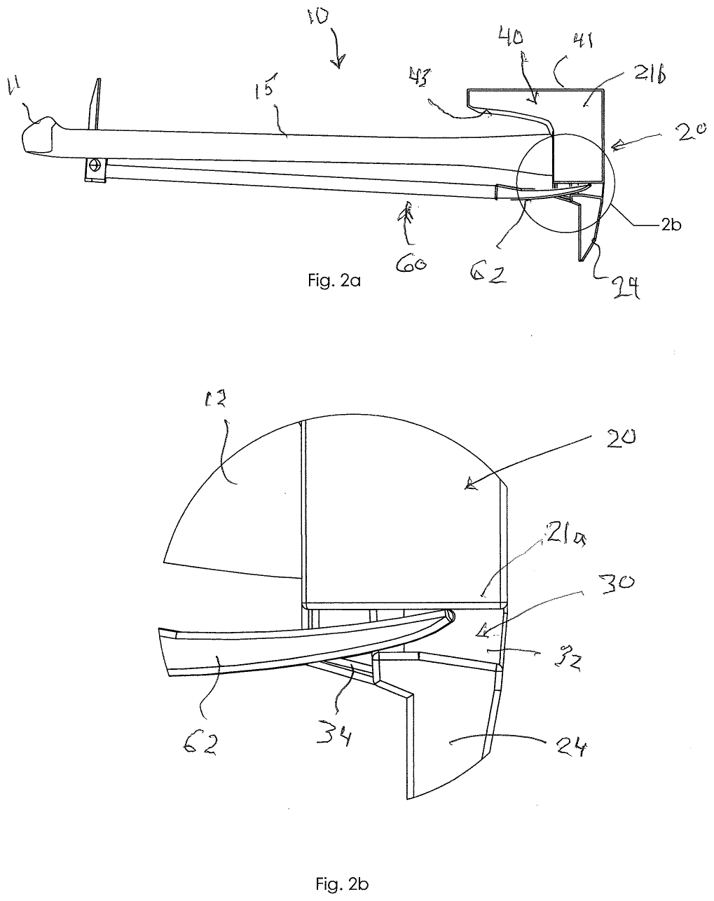

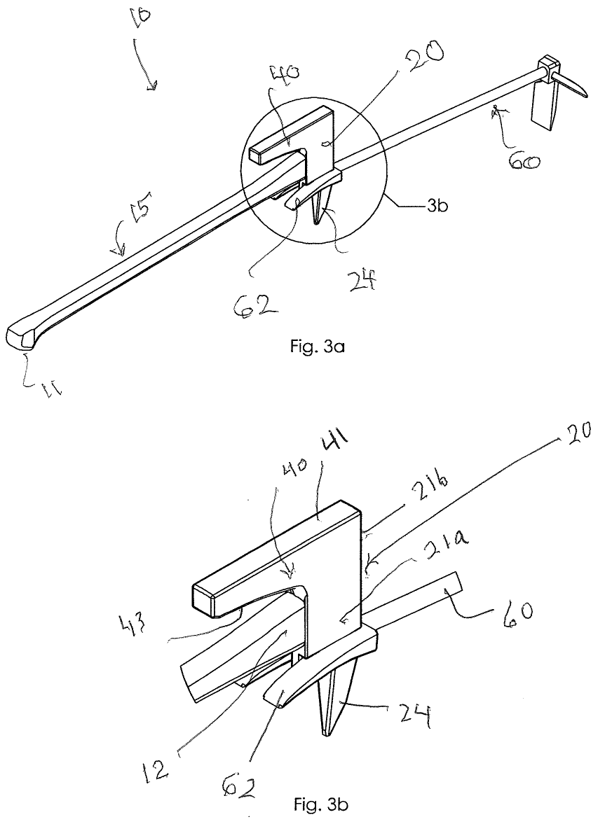

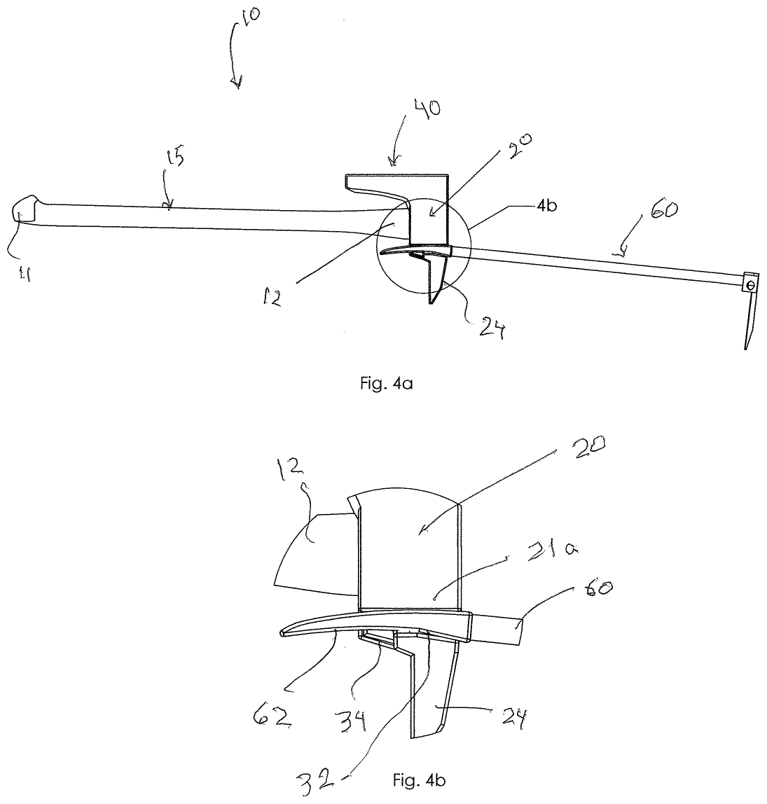

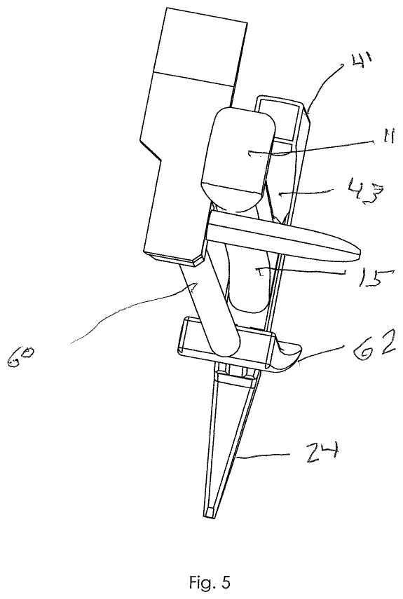

Preferably, a bridge member 30 may be situated between or intermediate the front end 21a of the axe head portion 20 and the pick-head 24. The bridge member 30 has a smaller profile than either the axe head portion 20 or pick-head 24 that it connects together. As shown more clearly in FIG. 2b, the bridge member 30 in cooperation with the front edge of the axe head portion 20 and pick-head 24 define a slot 32 having dimensions that are complementary to a forked end 62 of a Halligan tool 60. In an embodiment, the slot 32 may be referred to as a shoulder or as a void that is complementary to a portion of a Halligan tool 60. It is understood that the bridge member 30 and slot 32 enable the firefighting apparatus 10 and Halligan tool 60 to be attached together and carried single-handedly by a firefighter. This is significant in that both tools are commonly used by firefighters but are difficult to carry simultaneously with carrying other tools, manipulating a firehose, or even assisting another firefighter or a person attempting to escape a fire. As shown in FIGS. 3a and 3b, the forked end 62 of a Halligan tool 60 is equally received within the slot 32 from a reverse or opposite direction. More particularly, the slot 32 and bridge member 30 are configured to allow and enable the forked end 62 to be slidably received in the void or empty space defined between the front end 21a of the axe head portion 20 and pick-head 24. In an embodiment, the firefighting apparatus 10 may include 3 contact points that couple the Halligan 60 tool to the handle 15 and bridge member 30, respectively. More particularly, the forked end 62 may be secured to the bridge member 30 whereas the end (unnumbered) opposite the forked end may be coupled to, supported by, or pushed toward the butt and of the handle 15.

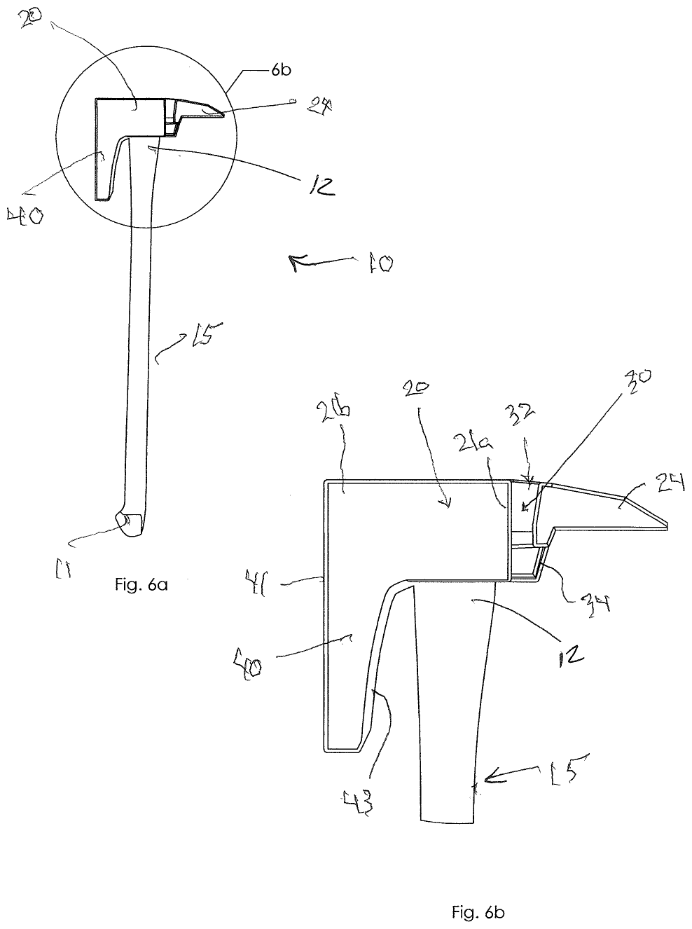

As shown in FIG. 6b, the bridge member 30 may also include a ring 34 defining an aperture suitable for receiving the end of a safety rope (not shown). Preferably, the ring 34 is constructed of a durable material so that the safety rope may be deployed such as to extend downwardly from a roof, a window sill, or other structure from which a firefighter may need to repel to safety. As will be described in further detail later, the firefighting apparatus 10 may include a structure that enables the firefighting tool to be anchored to a building structure in a stable manner that enables the firefighter to repel completely and safely using the safety rope.

In a critical aspect, the firefighting tool may include a beard 40 coupled to the rear end 21b of the axe head portion 20 (FIG. 6b). In fact, it may be preferable for the beard 40 to have a unitary construction with the axe head portion 20 and then to extend rearwardly and downwardly in relation to the rear end 21b. Described in even further detail, the beard 40 may define a rear surface 41 that is elongate in its vertical (i.e., top to bottom) configuration and may define a rear surface or rear edge that has a planar or flat configuration, and that is generally parallel to the longitudinal axis defined by the handle 15. The rear edge or rear surface 41 may be referred to as a strike plate that, in use, may be selectively or repeatedly slammed into building structures that need to be disrupted, destroyed, or otherwise opened up and accessed by the firefighter. Accordingly, the beard 40 should be constructed of a robust material such as steel. In a critical aspect, the elongate configuration of the beard 40 prevents the ax head portion 20 from becoming buried or stuck. In other words, the configuration of the beard worry is functional and critical.

In yet another critical aspect, the beard 40 may include an inner surface 44 opposite the rear surface 41. The inner surface 44 intentionally has a configuration that may be described as being forwardly ascending, angled, upwardly sloped, or rounded and that eventually merges with an under-surface of the axe head portion 20 (FIG. 6b). In some embodiments, the inner surface 44 may even define a rough or textured surface that is configured to grip the building materials against which the inner surface 44 may be wedged. For example, the firefighting tool 10 in general may be wedged and extended over a windowsill or within a fractured wall segment or the like so that the safety rope may be deployed from the ring 34—enabling the firefighter to repel to the ground or other safe area.

In use, a firefighter who is responding to a fire event, needs the best tools immediately accessible as he or she opens vent holes in a burning structure, gains fast access into a structure where persons or pets need to be rescued, or to enable water streams to flow more directly to actively burning areas. The firefighting tool includes a pick-head 24, striking plate (rear surface 41) that may be operated by swinging the tool by its handle 15. Further, the beard 40 not only defines a larger striking area than traditional tools, its inner surface 44 also provides a safety feature in cooperation with the ring 34 so that a firefighter can repel to safety if necessary.

It is understood that while certain forms of this invention have been illustrated and described, it is not limited thereto except insofar as such limitations are included in the following claims and allowable functional equivalents thereof.

What is claimed is:

1. A firefighting apparatus, comprising:
a handle having an elongate and linear configuration extending between a butt end and a neck end;
an axe head portion mounted to the neck end of the handle, the axe head portion having a front end and a rear end opposite the front end;
a pick-head operably mounted to the front end of the axe head portion, the pick-head having a pointed configuration suitable for prying open a structure; and
a beard mounted to the rear end of the axe head portion, the beard defining a rear surface that is elongate, planar, and parallel to the handle.

2. The firefighting apparatus as in claim 1, further comprising a bridge member connecting the front end of the axe head portion to the pick-head, the bridge member defining an aperture configured to receive a safety rope for securing and deploying the safety rope.

3. The firefighting apparatus as in claim 2, wherein said pick-head is positioned forwardly of said axe head portion and extends laterally and perpendicular to an imaginary longitudinal axis defined by that handle.

4. The firefighting apparatus as in claim 1, wherein said beard has a unitary construction with said axe head portion.

5. The firefighting apparatus as in claim 1, wherein the beard includes an inner surface opposite the rear surface, the inner surface having a forwardly ascending configuration that merges with the axe head portion.

6. The firefighting apparatus as in claim 5, wherein the inner surface has a rounded or arcuate configuration that is complementary to a building fixture.

7. The firefighting apparatus of claim 1, wherein the bridge and pick-head, together, define a slot for selectively receiving a forked end of a Halligan tool so that said apparatus and the Halligan tool are transportable together.

8. The firefighting apparatus as in claim 7, wherein said pick-head has a tapered configuration for receiving the forked end of the Halligan tool in a friction fit attachment.

9. The firefighting apparatus of claim 2, wherein the aperture defined by the bridge member is configured to facilitate rapid attachment and detachment of the safety rope.

10. The firefighting apparatus of claim 1, wherein the pick-head is formed of a hardened material suitable for penetrating structural materials.

11. The firefighting apparatus of claim 1, wherein the handle is constructed from a material selected from the group consisting of fiberglass, steel, aluminum, and composite materials.

12. The firefighting apparatus of claim 1, wherein the rear surface of the beard is configured for use as a striking tool.

13. A firefighting apparatus, comprising:
a handle having an elongate and linear configuration extending between a butt end and a neck end;
an axe head portion mounted to the neck end of the handle, the axe head portion having a front end and a rear end opposite the front end;
a pick-head operably mounted to the front end of the axe head portion, the pick-head having a pointed configuration suitable for prying open a structure; and
a beard mounted to the rear end of the axe head portion, the beard defining (1) a rear surface that is elongate, planar, and parallel to the handle and (2) an inner surface opposite the rear surface that defines a forwardly ascending configuration that merges with the axe head portion.

14. The firefighting apparatus as in claim 13, wherein the inner surface has a rounded or arcuate configuration that is complementary to a building fixture.

15. The firefighting apparatus as in claim 13, further comprising a bridge member connecting the front end of the axe head portion to the pick-head, the bridge member defining a ring configured to receive and secure a safety rope for deployment therefrom.

16. The firefighting apparatus of claim 15, wherein the bridge and pick-head, together, define a slot for selectively receiving a forked end of a Halligan tool so that said firefighting apparatus and the Halligan tool are transportable when coupled together.

17. The firefighting apparatus as in claim 15, wherein said pick-head has a tapered configuration for receiving the forked end of the Halligan tool in a friction fit attachment.

18. The firefighting apparatus of claim 13, wherein the pick-head is formed of a hardened material suitable for penetrating structural materials.

19. The firefighting apparatus of claim 13, wherein the handle is constructed from a material selected from the group consisting of fiberglass, steel, aluminum, and composite materials.

20. A firefighting apparatus, comprising:
a handle having an elongate and linear configuration extending between a butt end and a neck end;
an axe head portion mounted to the neck end of the handle, the axe head portion having a front end and a rear end opposite the front end;
a pick-head operably mounted to the front end of the axe head portion, the pick-head having a pointed configuration suitable for prying open a structure; and
a beard mounted to the rear end of the axe head portion, the beard defining (1) a rear surface that is elongate, planar, and parallel to the handle and (2) an inner surface opposite the rear surface that defines a forwardly ascending configuration that merges with the axe head portion; and
a bridge member connecting the front end of the axe head portion to the pick-head, the bridge member defining a ring configured to receive and secure a safety rope for deployment therefrom;
wherein the bridge and pick-head, together, define a slot for selectively receiving a forked end of a Halligan tool so that said firefighting apparatus and the Halligan tool are transportable when coupled together.
